(19) United States
(12) Patent Application Publication
(10) Pub. No.: US 2013/0189476 A1
(43) Pub. Date: Jul. 25, 2013

(54) STEP MAT WITH FABRIC MATERIAL AND METHOD OF MANUFACTURING THE SAME

(71) Applicant: SU-TUAN HSU TANG, Tao Yuan Hsien (TW)

(72) Inventor: SU-TUAN HSU TANG, Tao Yuan Hsien (TW)

(21) Appl. No.: 13/354,347

(22) Filed: Jan. 20, 2012

(51) Int. Cl. A47G 27/00; B32B 3/06; B29C 70/68

(52) U.S. Cl. 428/99; 156/66

(57) ABSTRACT

A step mat and a method of manufacturing the same are provided. The method includes the steps of: providing a fabric material; averaging tension of the fabric material by stretching; increasing a density of the fabric material by pressing; removing water from the fabric material by thermal illumination; providing a middle layer material; applying a layer of a colloid paste onto the middle layer material to adhere the middle layer material to the fabric material; foaming the colloid paste by thermal baking; cooling the colloid paste, which is foamed by the thermal baking, together with the middle layer material and the fabric material, so that a layer of a glue pad covered with the middle layer material is formed on the fabric material; pressing the glue pad and fabric material to perform thickness correction and form a semi-facture of the step mat; and combining suckers with the glue pad.

### BACKGROUND OF THE INVENTION

(1) Field of the Invention

The invention relates to a step mat and a manufacturing method thereof, and more particularly to a step mat with a fabric material and a manufacturing method thereof.

(2) Description of the Prior Art

Step mats include, for example, a step mat laying on the doorway or the kitchen floor, a bathroom pad placed on the bathroom floor to absorb the water and provide the slip-resistant property, and an anti-slipping pad placed in the bathtub. At present, a soft pad, serving as the step mat, is manufactured by foaming a plastic material. The anti-slipping pad used in the bathtub is a plastic pad body designed with mesh patterns.

Although the step mats in the form of the plastic soft pad have the good elasticity, they have the drawbacks of the incapability of absorbing the water and the sweat. When the water or the sweat drops on the step mat, the step mat tends to be slippery to cause the danger of slip and cause the dirtiness to be formed, so that the step mat cannot be easily cleaned. The bathroom pads can replace the wet and slippery floor of the bathroom and have the functions of being stepped by the human feet. However, when a predetermined number of water drops are attached to the surface of the plastic pad body, the surface still becomes slippery.

In order to solve the above-mentioned drawbacks of the prior arts, some users only have to passively lay the towels on the step mats. However, the towel is only laid on the step mat and is not fixed to the step mat. During the using process, the laid towel tends to be messed, so that the drawback that the towel often has to be laid again is caused, or the user tends to fall down and encounters danger during the using process due to the sliding of the towel. Regarding the bathroom pad, a bath towel or a towel is directly laid on the bathroom floor to become moisturized and prevent the slip. However, after the towel is moisturized, the friction between the towel and the floor is decreased, so the slippery condition is still caused when the human feet step on the moisturized towels.

### SUMMARY OF THE INVENTION

A primary object of the invention is to provide a step mat with a fabric material and a method of manufacturing the step mat, wherein one surface of a glue pad covered with a middle layer material has the fabric material so that the step mat can absorb the water and the sweat through the fabric material, the dangerous conditions of slipperiness, slipping and falling down cannot be caused, and the step mat can be directly put into a washer and washed. Also, the fabric material cannot be messed or crumpled during the using process, and the step mat can be easily cleaned so that the bacteria growth and infection cannot be caused. Furthermore, suckers are combined with the other surface of the glue pad to form a bathroom pad, and the positioning strength between the bathroom pad and the bathroom floor can be increased using the suckers.

A secondary object of the invention is to provide a step mat with a fabric material and a method of manufacturing the step mat, wherein a concave-convex structure is further formed on one surface of the fabric material so that the step mat still has the anti-slip effect after being moisturized and encountering the soap foam.

The invention achieves the above-identified objects by providing a method of manufacturing a step mat with a fabric material. The method includes a fabric material providing step, a tension averaging step, a front-stage pressing step, a water removing step, a middle layer material providing step, a coating step, a foaming step, a cooling step, a post-stage pressing step and a sucker combining step. In the tension averaging step, tension of the fabric material is averaged by way of stretching. In the front-stage pressing step, a density of the fabric material is increased by way of pressing. In the water removing step, water is removed from the fabric material by way of thermal illumination. In the coating step, a layer of a colloid paste is applied onto the middle layer material and the middle layer material is adhered to the fabric material by the colloid paste. In the foaming step, the colloid paste is foamed by way of thermal baking. In the cooling step, the colloid paste, which is foamed after the thermal baking, together with the middle layer material and the fabric material are cooled, so that a layer of a glue pad covered with the middle layer material is formed on the fabric material. In the post-stage pressing step, the glue pad and the fabric material are pressed to perform thickness correction and form a semi-facture of the step mat. In the sucker combining step, suckers are combined with the glue pad.

Thus, the step mat can absorb the sweat, the dangerous conditions of slipperiness, slipping and falling down cannot be caused, and the step mat can be directly put into a washer and washed. Also, the fabric material cannot be messed or crumpled during the using process, and the step mat can be easily cleaned so that the bacteria growth and infection cannot be caused. Furthermore, the suckers are combined with the other surface of the glue pad to form a bathroom pad, and the positioning strength between the bathroom pad and the bathroom floor can be increased using the suckers.

The invention additionally provides a step mat including a fabric material, a glue pad and suckers. The fabric material has a fabric material organization with weaving gaps. The glue pad is combined with the middle layer material by way of foaming. The combination of the glue pad extends to one surface of the fabric material, covers and penetrates through the middle layer material, and extends deeply inside the weaving gaps of the fabric material so that the glue pad is completely combined with the fabric material organization. Each of the suckers is combined with one surface of the glue pad.

Thus, the step mat can absorb the sweat, the dangerous conditions of slipperiness, slipping and falling down cannot be caused, and the step mat can be directly put into a washer and washed. Also, the fabric material cannot be messed or crumpled during the using process, and the step mat can be easily cleaned so that the bacteria growth and infection cannot be caused. Furthermore, the suckers are combined with the other surface of the glue pad to form a bathroom pad, and the positioning strength between the bathroom pad and the bathroom floor can be increased using the suckers.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a flow arrangement diagram showing a manufacturing method of the invention.

FIG. 2 is a flow chart showing the manufacturing method of the invention.

FIG. 3 is a pictorial view showing a step mat, manufactured according to the manufacturing method of the invention, with the fabric material facing upwards.

FIG. 4 contains a cross-sectional view and an enlarged partial cross-sectional view showing the step mat manufactured according to the manufacturing method of the invention.

FIG. 5 is a pictorial view, at another viewing angle, showing the step mat, which is manufactured according to the manufacturing method of the invention and has the glue pad facing upwards.

FIG. 6 contains an enlarged partial view and a 6-6 cross-sectional view showing the step mat of FIG. 5 of the invention.

FIG. 7 is a pictorial view showing a middle layer material used in the invention.

### DETAILED DESCRIPTION OF THE PREFERRED EMBODIMENTS

The invention provides a step mat with a fabric material and a method of manufacturing such step mat so that the step mat can absorb the water and the sweat through the fabric material, the dangerous conditions of slipperiness, slipping and falling down cannot be caused, and the step mat can be directly put into a washer and washed. Also, the fabric material cannot be messed or crumpled during the using process, and the step mat can be easily cleaned so that the bacteria growth and infection cannot be caused. More particularly, the positioning strength between the floor and the step mat can be increased.

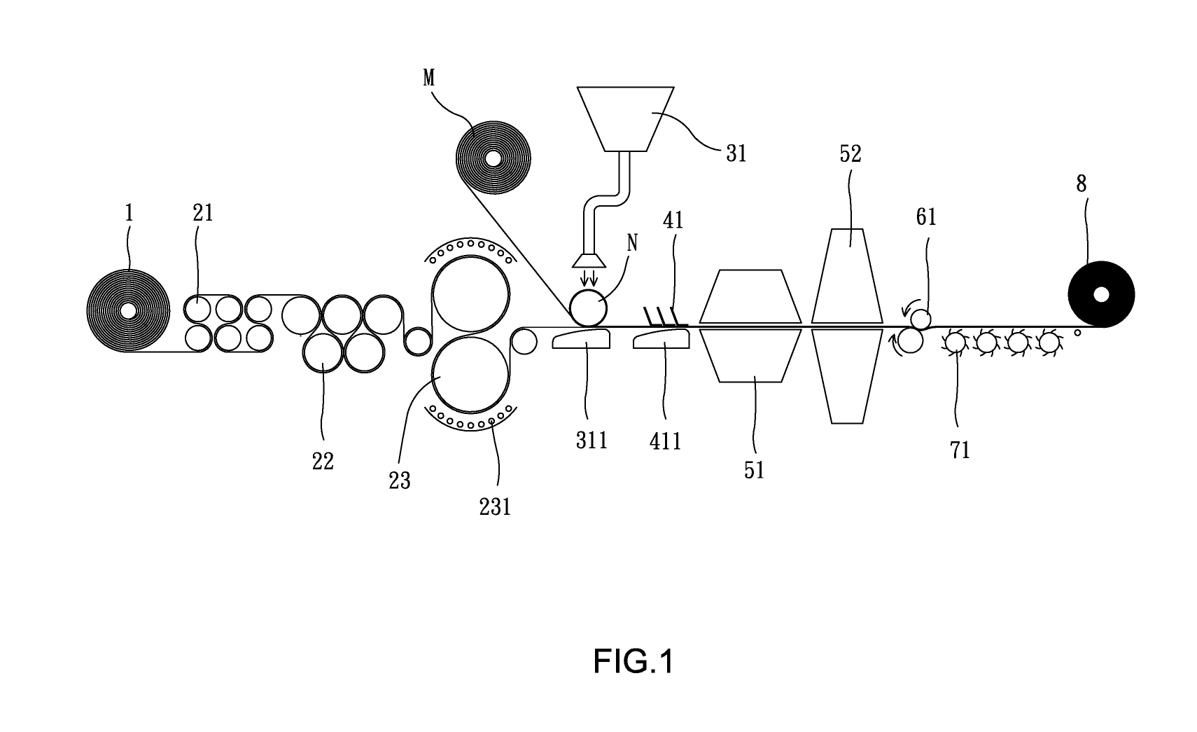

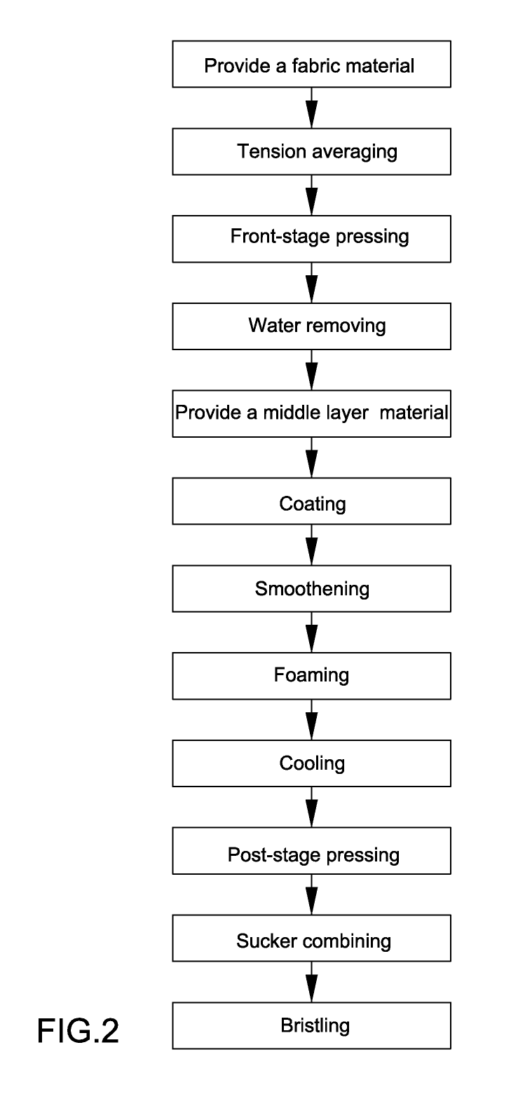

Referring to FIGS. 1 and 2, the manufacturing method of the invention includes a fabric material providing step, a tension averaging step, a front-stage pressing step, a water removing step, a middle layer material providing step, a coating step, a smoothening step, a foaming step, a cooling step, a post-stage pressing step, a bristling step and a sucker combining step.

In the fabric material providing step, a fabric material 1 is provided. The fabric material 1 may be an ultra-fine fiber cloth or towel cloth, and the ultra-fine fiber cloth may be composed of natural or artificial fibers such as cotton, polyester, Nylon and the like. In addition, the ultra-fine fiber cloth or towel cloth may be made by weaving a bamboo charcoal yarn to possess the deodorization effect, or may be made by weaving a polyethylene terephthalate (PETE) bottle recycled yarn.

In the tension averaging step, the tension of the fabric material 1 is averaged by way of stretching. As shown in the drawing, the fabric material 1 wraps around and between a plurality of tension roller sets, each of which includes a plurality of tension rollers 21. Using the tension rollers 21 can adjust the fabric material 1 to the predetermined width, while the tension of the fabric material 1 is averaged by way of stretching.

In the front-stage pressing step, the density of the fabric material 1 is increased by way of pressing. As shown in the drawing, the fabric material 1 wraps around and between a plurality of front-stage pressure rollers 22 so that the fabric material 1 can be compacted and densified (the weaving gap of the fabric material 1 is reduced), the density of the fabric material 1 is increased, the penetration of the colloid paste can be avoided, the amount of the colloid paste absorbed by the fabric material 1 can be decreased, and the object of saving the colloid paste can be achieved.

In the water removing step, the water is removed from the fabric material 1 by way of thermal illumination (thermal energy illumination). As shown in the drawing, the fabric material 1 wraps around and between at least two heating rollers 23, wherein an electric heating lamp set is disposed on each of opposite sides of the two heating rollers 23, and each of the electric heating lamp sets includes a plurality of electric heating lamps 231. The thermal illumination of the electric heating lamps 231 on the fabric material 1 is utilized to remove the water from the fabric material 1. Thus, it is possible to prevent the fabric material 1 containing water from affecting the surface state after the coating step and to prevent the bubbles from being produced.

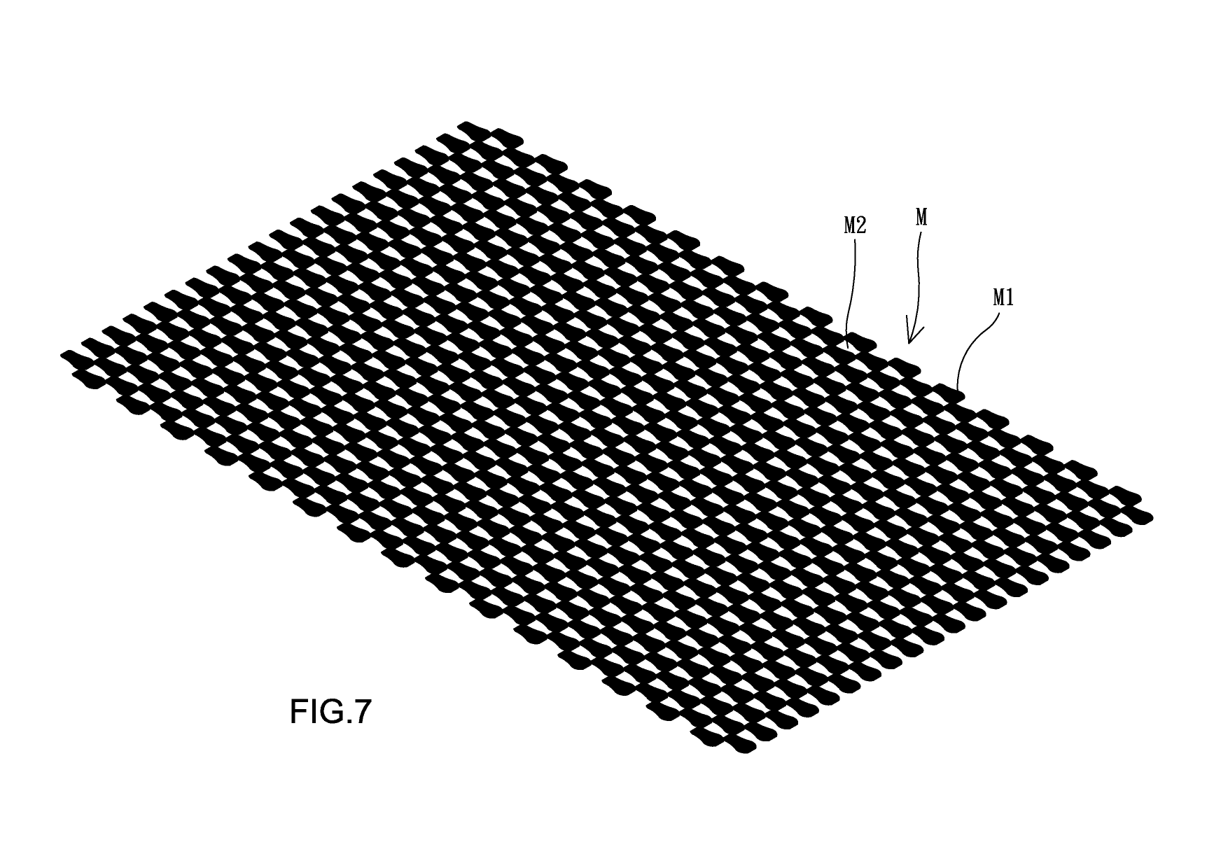

In the middle layer material providing step, a middle layer material M is stacked on the fabric material 1. As shown in FIG. 7, the middle layer material M may be a net fabric shown in the drawing. The net fabric has many mesh wires M1 and many meshes M2, as shown in the drawing. In addition, the middle layer material M may be a cloth (not shown) without opening.

In the coating step, a layer of the colloid paste, which may be selected from PVC, PER, TPU, TPE, TPR and the like, is applied onto the fabric material 1. As shown in the drawing, the colloid paste accommodated within a material bucket 31 is outputted and attached to a coating roller N. A supporting element 311 is disposed below the fabric material 1 and the middle layer material M corresponding to the coating roller N to support the coating roller N, the middle layer material M and the fabric material 1, wherein the support can make the coated material become even. Thus, the coating roller N applies the colloid paste onto the middle layer material M while adheres the colloid paste, covered with the middle layer material M, to the fabric material 1. The material bucket 31 may be implemented by an inverter duty motor for controlling the feeding amount.

In the smoothening step, the colloid paste applied in the coating step is smoothened. As shown in the drawing, a plurality of scrapers 41 is disposed above the fabric material 1 and the middle layer material M applied with the colloid paste. The scrapers 41 smoothen the colloid paste on the translating (from left to right) middle layer material M and fabric material 1. A supporting element 411 is disposed below the fabric material 1 and the middle layer material M corresponding to the scrapers 41 to support the fabric material 1 and the middle layer material M. Of course, the smoothening step may also be performed by scrapers (not shown) with scratches so that the surface of the colloid paste can be smoothened and scratched to form textures to enhance the anti-slip effect.

Each of the supporting elements 311 and 411 may be in the form of a substrate, or a plurality of small rollers arranged in parallel (not shown).

In the foaming step, the colloid paste is foamed by way of thermal baking. As shown in the drawing, the fabric material 1 and the middle layer material M applied with the colloid paste pass through two opposite ovens 51, so that a soft pad closely combined with the middle layer material M and the fabric material 1 is formed after the colloid paste attached to the middle layer material M and the fabric material 1 is foamed and shaped.

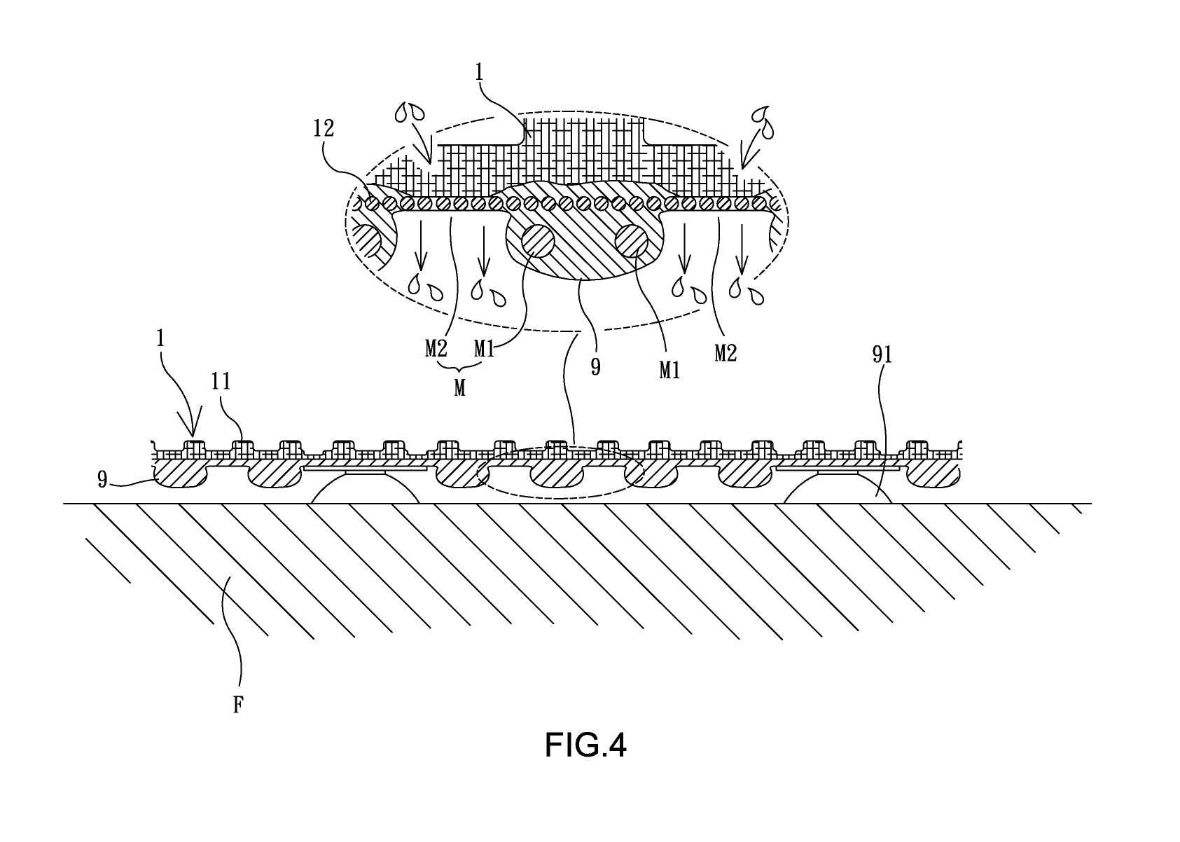

In the cooling step, the colloid paste, formed after the thermal baking and foaming step, together with the middle layer material M and the fabric material 1, are cooled so that a layer of a glue pad 9 (see FIG. 4) covered with the middle layer material M is formed on the fabric material 1. As shown in FIGS. 1 and 2, the fabric material 1 and the middle layer material M with the foamed colloid paste pass through two opposite cooling devices 52 so that a layer of the elastic glue pad 9 covered with the middle layer material M is formed on the fabric material 1.

In the post-stage pressing step, the glue pad 9 together with the fabric material 1 are pressed so that the thickness correction of the step mat is performed. As shown in the drawing, the fabric material 1 formed with the glue pad 9 wraps around and between a plurality of post-stage pressure rollers 61, so that the thicknesses of the glue pad 9 and the fabric material 1 can be corrected by way of pressing.

In the bristling step, a plurality of bristle rollers 71 is disposed below the fabric material 1. The bristle rollers 71 perform the bristling operations on the fine bristles of the fabric material 1, so that the collapsed fine bristles of the fabric material 1 formed after the coating step and the foaming step can be bristled and ordered. Thus, a semi-facture 8, which has not been cut and seamed, can be manufactured.

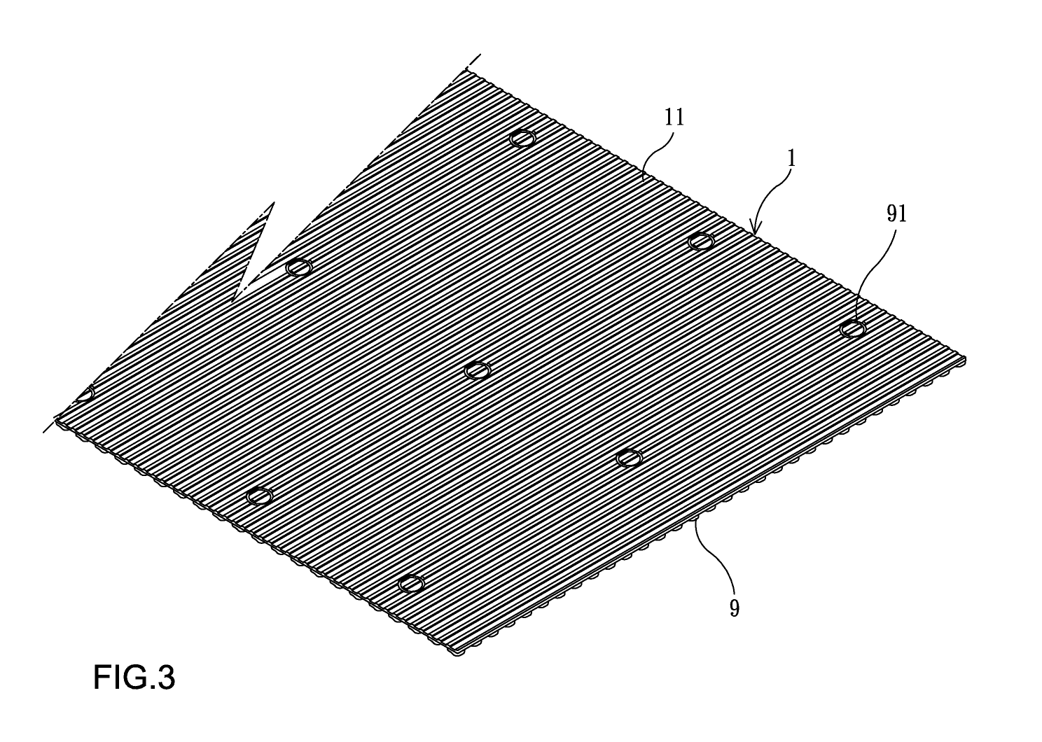

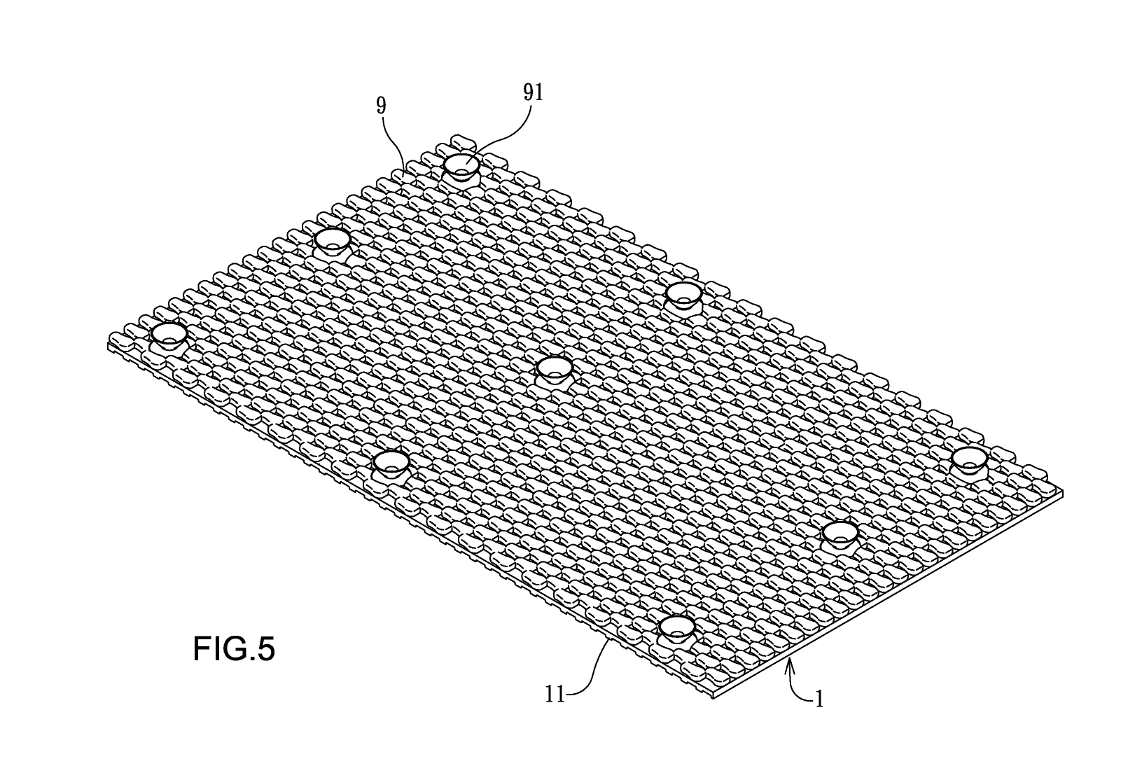

In the sucker combining step, suckers 91 are combined with the glue pad 9. As shown in FIGS. 3 to 5, the suckers 91 are printed on one surface of the glue pad 9 by a high frequency wave.

In addition, the fabric material 1 provided in the fabric material providing step may have a plurality of openings (not shown), wherein the colloid paste can enter the openings so that the fabric material 1 appears the pattern (not shown) arranged according to the openings. Of course, if the arrangement of the openings has been designed, the fabric material 1 of the step mat of the invention can appear the predetermined pattern. Also, one surface of the fabric material 1 may be formed with a concave-convex structure 11, which is formed by weaving a plurality of thick cloth strips and a plurality of thin cloth strips alternately. The concave-convex structure 11 also enhances the friction of the used surface of the step mat of the invention so that the anti-slip effect between the step mat and the human body can be enhanced.

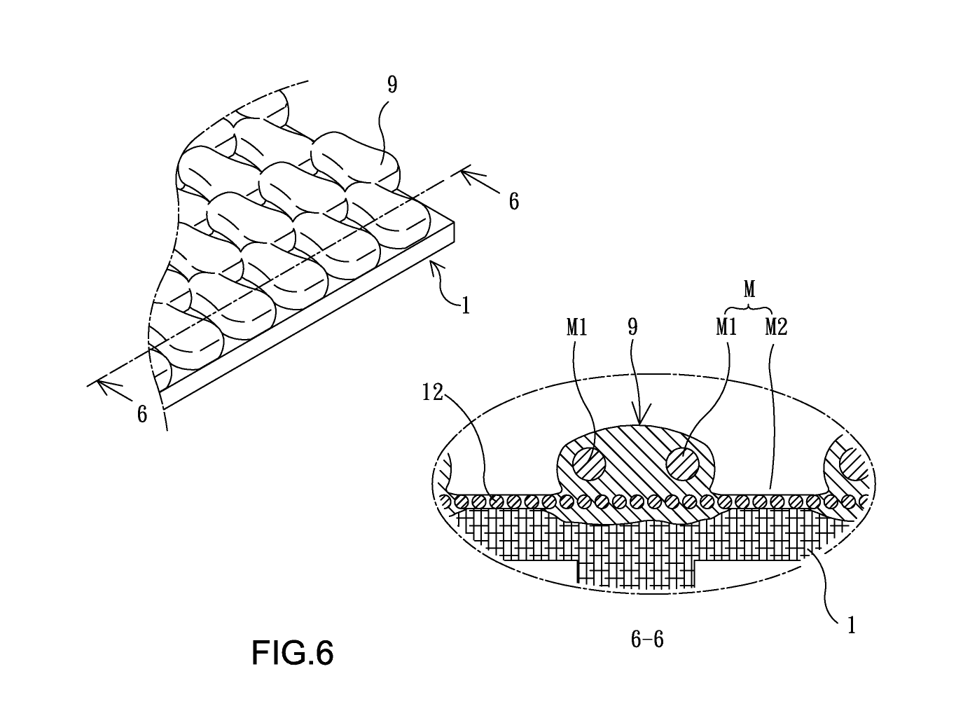

As shown in FIG. 2, the step mat with the fabric material formed according to the above-mentioned manufacturing method includes the fabric material 1 and the glue pad 9. The fabric material 1 has a fabric material organization (not shown), which includes a plurality of weaving gaps (not shown). The glue pad 9 is combined with the middle layer material M by way of foaming. The combination of the glue pad 9 extends to one surface of the fabric material 1 (the glue pad is combined with one surface of the fabric material 1 through the material (colloid paste) of the glue pad by way of foaming), and the combination thereof covers and penetrates through the middle layer material M and is deeply inside the weaving gaps (not shown) of the fabric material 1 and thus completely combined with the fabric material organization (not shown). Thus, the glue pad 9 and the fabric material 1 cannot be separated from each other due to the external force or the washing of the washer, and the excellent combination strength can be obtained. Each of the suckers 91 is printed on one surface of the glue pad 9 by the high frequency wave. As shown in the enlarged partial cross-sectional views of FIGS. 4 and 6, the braided wires 12 of the fabric material 1 are combined with a portion of the glue pad 9.

The suckers 91 can further enhance the anti-slip effect while possessing the massage effects. As shown in FIG. 4, the presence of the sucker 91 makes the step mat become slightly protrudent from the portion of the step mat. When the human foot steps on the portion of the step mat, the massage effect can be obtained. In addition, the step mat may further be used on a bathroom floor F, and the suckers 91 can be attached to the wet bathroom floor F to achieve the real anti-slip effect.

Furthermore, the other surface of the fabric material 1 further has the concave-convex structure 11, which is formed by weaving a plurality of thick cloth strips and a plurality of thin cloth strips alternately. The concave-convex structure 11 also enhances the friction of the used surface of the step mat of the invention so that the anti-slip effect between the step mat and the human body can be enhanced.

In addition, the fabric material 1 may also have many openings (not shown), wherein the glue pad 9 can also enter the openings so that the fabric material 1 appears the pattern (not shown) arranged according to the openings. Of course, if the arrangement of the openings has been designed, the fabric material 1 of the step mat of the invention can appear the predetermined pattern.

The fabric material 1 may be an ultra-fine fiber cloth or towel cloth, and the ultra-fine fiber cloth or towel cloth may be woven using a bamboo charcoal yarn or a PETE bottle recycled yarn. As shown in FIGS. 4, 6 and 7, the middle layer material M may be a net fabric with many meshes M2, and the glue pad 9 covers the mesh wires M1 of the net fabric by way of foaming.

In summary, the step mat with the fabric material and the method of manufacturing the same according to the invention have the following advantages. The fabric material 1 and the glue pad 9 covered with the middle layer material M are directly combined together to have the elasticity of the glue pad 9, the anti-slip effect between the step mat and the floor, and the water and sweat absorbing effects of the fabric material 1. The used surface of the step mat has one layer of the fabric material 1 to have the water and sweat absorbing effects, and the slipperiness and slipping can be avoided. More particularly, the fabric material 1 in use cannot be messed or crumpled, and the step mat can be easily cleaned so that the bacteria growth and infection cannot be caused. Because the fabric material 1 uses the ultra-fine fiber cloth, the ultra-strong water and sweat absorbing abilities as well as the good soft touch and dense touch can be obtained. Because the bottom portion of the step mat is the glue pad 9, covered with the middle layer material M and formed by way of foaming, and has the elasticity and anti-slip effect, the overall comfort of use can be further enhanced. Because the ultra-fine fiber cloth can be formed by weaving the bamboo charcoal yarn, the deodorization effect can be obtained. Unlike the prior art, in which the sweat is accumulated in the groove of the glue pad, the sweat can be absorbed by the used surface of the step mat (i.e., the fabric material 1). So, the step mat can be easily cleaned. More particularly, because the structural strength of the combination between the fabric material 1 and the glue pad 9, covered with the middle layer material M, is extremely strong and firm and the combination between the fabric material and the glue pad covered with the middle layer material is the direct combination without an adhesive agent, the overall step mat can be directly placed into the washer and washed therein, and the utility and the convenience are significantly enhanced. Because the provided fabric material 1 may have the openings (not shown), the colloid paste can enter the openings so that the fabric material 1 can appear the pattern arranged according to the openings. Because the other surface of the fabric material 1 has the concave-convex structure 11, the used surface of the step mat of the invention also has the better anti-slip effect. More particularly, when the step mat is used as the bathroom pad, the step mat still possesses the anti-slip effect because of the concave-convex structure 11 even if the surface fabric material 1 is moisturized and encounters the soap foam. In addition, the fabric material 1 can stop the hair, and the net fabric type middle layer material M is advantageous to the water drainage and the ventilation (see the enlarged partial cross-sectional view of FIG. 4) through the meshes M2. Thus, the step mat is quite suitable for the shower room. The suckers 91 disposed on the glue pad 9 firmly grasp the floor and increase the positioning strength between the glue pad 9 and the floor (e.g., the bathroom floor), and further have the anti-slip effect and the incidental massage effect, or even the gaps between the suckers 91 can be used as the water drainage and the ventilation. The step mat of the invention is also suitable for the water environment and the slippery floor environment, such as the bathroom, the kitchen or the like.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A method of manufacturing a step mat with a fabric material, the method comprising:
a step of providing the fabric material;
a tension averaging step of averaging tension of the fabric material by way of stretching;
a front-stage pressing step of increasing a density of the fabric material by way of pressing;
a water removing step of removing water from the fabric material by way of thermal illumination;
a step of providing a middle layer material;
a coating step of applying a layer of a colloid paste onto the middle layer material and adhering the middle layer material to the fabric material by the colloid paste;
a foaming step of foaming the colloid paste by way of thermal baking;
a cooling step of cooling the colloid paste, which is foamed after the thermal baking, together with the middle layer material and the fabric material, so that a layer of a glue pad covered with the middle layer material is formed on the fabric material;
a post-stage pressing step of pressing the glue pad and the fabric material to perform thickness correction and form a semi-facture of the step mat; and
a sucker combining step of combining suckers with the glue pad.

2. The method according to claim 1, wherein in the tension averaging step, the fabric material wraps around and between tension roller sets, each of which comprises tension rollers.

3. The method according to claim 1, wherein in the front-stage pressing step, the fabric material wraps around and between front-stage pressure rollers.

4. The method according to claim 1, wherein in the water removing step, the fabric material wraps around and between at least two heating rollers, two electric lamp sets are respectively disposed on opposite sides of the two heating rollers, and each of the electric lamp sets comprises electric lamps.

5. The method according to claim 1, wherein in the coating step, the colloid paste accommodated within a material bucket is outputted and attached to a coating roller, a supporting element is disposed below the middle layer material and the fabric material corresponding to the coating roller, the coating roller applies the colloid paste onto the middle layer material, while the colloid paste covered with the middle layer material is adhered to the fabric material.

6. The method according to claim 1, further comprising, after the coating step, a smoothening step of smoothening the colloid paste applied in the coating step.

7. The method according to claim 6, wherein in the smoothening step, scrapers are disposed above the fabric material applied with the colloid paste, the scrapers smoothen the colloid paste on the translating middle layer material and fabric material, and a supporting element is disposed below the fabric material corresponding to the scrapers.

8. The method according to claim 7, wherein each of the scrapers has scratches for scratching the glue pad to form textures.

9. The method according to claim 5, wherein the supporting element is one of a substrate and an arrangement of parallel small rollers.

10. The method according to claim 7, wherein the supporting element is one of a substrate and an arrangement of parallel small rollers.

11. The method according to claim 1, wherein in the foaming step, the middle layer material and the fabric material applied with the colloid paste pass through two opposite ovens so that the colloid paste is foamed.

12. The method according to claim 1, wherein in the cooling step, the middle layer material and the fabric material with the colloid paste foamed pass through two opposite cooling devices, so that the layer of the glue pad covered with the middle layer material is formed on the fabric material.

13. The method according to claim 1, wherein in the post-stage pressing step, the fabric material formed with the glue pad wraps around and between post-stage pressure rollers to correct thicknesses of the glue pad and the fabric material.

14. The method according to claim 1, further comprising, after the post-stage pressing step, a bristling step, in which bristle rollers are disposed below the fabric material, wherein the bristle rollers perform bristling operations on fine bristles of the fabric material.

15. The method according to claim 1, wherein the fabric material provided in the step of providing the fabric material has openings, and the colloid paste enters the openings so that the fabric material appears a pattern arranged according to the openings.

16. The method according to claim 1, wherein the fabric material provided in the step of providing the fabric material is one of an ultra-fine fiber cloth and a towel cloth.

17. The method according to claim 16, wherein one of the ultra-fine fiber cloth and the towel cloth is woven using one of a bamboo charcoal yarn and a PETE bottle recycled yarn.

18. The method according to claim 1, wherein the fabric material provided in the step of providing the fabric material has one surface formed with a concave-convex structure.

19. The method according to claim 1, wherein the middle layer material is a net fabric with meshes, and the colloid paste covers the meshes of the net fabric.

20. The method according to claim 1, wherein in the sucker combining step, the suckers are printed on one surface of the glue pad by a high frequency wave.

21. A step mat manufactured according to the method of claim 1, the step mat comprising:
the fabric material having a fabric material organization comprising weaving gaps;
the glue pad combined with the middle layer material by way of foaming, wherein combination of the glue pad extends to one surface of the fabric material, covers and penetrates through the middle layer material, and extends deeply inside the weaving gaps of the fabric material so that the glue pad is completely combined with the fabric material organization; and
the suckers, each of which is combined with one surface of the glue pad.

22. The step mat according to claim 21, wherein the other surface of the fabric material has a concave-convex structure.

23. The step mat according to claim 21, wherein the fabric material is one of an ultra-fine fiber cloth and a towel cloth.

24. The step mat according to claim 23, wherein one of the ultra-fine fiber cloth and the towel cloth is woven using one of a bamboo charcoal yarn and a PETE bottle recycled yarn.

25. The step mat according to claim 21, wherein the middle layer material is a net fabric with meshes, and the glue pad covers the meshes of the net fabric by way of foaming.
